(19) United States
(12) Patent Application Publication
(10) Pub. No.: US 2012/0091314 A1
(43) Pub. Date: Apr. 19, 2012

(54) MOLD

(75) Inventors: Jian-ming Li, Tu Cheng (TW); Xiao-ping Wu, Tu Cheng (TW); Shih-hsiung Ho, Tu Cheng (TW)

(73) Assignee: Cheng Uei Precision Industry Co., LTD., Tu Cheng City (TW)

(21) Appl. No.: 12/907,972

(22) Filed: Oct. 19, 2010

(51) Int. Cl. B29C 45/40

(52) U.S. Cl. 249/68

(57) ABSTRACT

A mold includes a static mold, a static-mold ejector mechanism, a dynamic mold mating with the static mold, and a dynamic-mold ejector mechanism. The static mold has a static-mold moving-space and a positioning-rod hole. The static-mold ejector mechanism is movably mounted in the static mold and includes a static-mold ejector plate mounted in the static-mold moving-space, at least one static-mold ejector component, at least one positioning-rod movably received in the positioning-rod hole, and at least one static-mold spring. The static-mold ejector component and the positioning-rod are mounted on the static-mold ejector plate. The static-mold spring can push the static-mold ejector plate to drive the positioning-rod against the dynamic mold. The mold prevents the finished-product from sticking in a static mold with the arrangement of the static-mold ejector mechanism, which provides the static-mold spring to push the static-mold ejector plate to drive the static-mold ejector component to push the finished-product out.

### BACKGROUND OF THE INVENTION

1. Field of the Invention

The present invention generally relates to a mold, and in particular to a mold that can prevent the finished-products from sticking to a static mold.

2. The Related Arts

Reference is now made to FIG. 1 of the attached drawings, which shows a conventional mold 100′. The mold 100′ comprises a static mold 10′, a dynamic mold 20′ which mates with the static mold 10′, and an ejector mechanism 30′ which is movably mounted on the dynamic mold 20′.

When the mold 100′ is opened after a finished-product has been formed, the static mold 10′ often gets sticking to the finished-product. Thus, the finished-product will be broken when the mold 100′ is closed again, and the broken product affects the subsequent operation of the mold 100′.

### SUMMARY OF THE INVENTION

An objective of the present invention is to overcome the problem discussed above by providing a mold which can prevent the finished-product from sticking to a static mold.

To achieve the above objective, the present invention provides a mold, which comprises a static mold, a static-mold ejector mechanism, a dynamic mold mating with the static mold, and a dynamic-mold ejector mechanism. The static mold comprises an upper fixing plate and a static-mold plate, and forms a static-mold moving-space and a positioning-rod hole. The static-mold ejector mechanism is movably mounted in the static mold and comprises a static-mold ejector plate mounted in the static-mold moving-space, at least one static-mold ejector component, at least one positioning-rod which is movably received in the positioning-rod hole, and at least one static-mold spring. The static-mold ejector component and the positioning-rod are mounted on the static-mold ejector plate. The dynamic-mold ejector mechanism is movably mounted in the dynamic mold, wherein the positioning-rod hole extends through the static mold in the direction toward the dynamic mold, and the static-mold spring can push the static-mold ejector plate to drive the positioning-rod against the dynamic mold.

As described above, the mold according to the present invention can prevent the finished-product from sticking to a static mold with the arrangement of the static-mold ejector mechanism, which provides the static-mold spring to push the static-mold ejector plate to drive the static-mold ejector component to push the finished-product out.

### BRIEF DESCRIPTION OF THE DRAWINGS

The present invention will be apparent to those skilled in the art by reading the following description of a preferred embodiment of the present invention, with reference to the attached drawings, in which:

FIG. 1 is a cross-sectional view of a conventional mold.

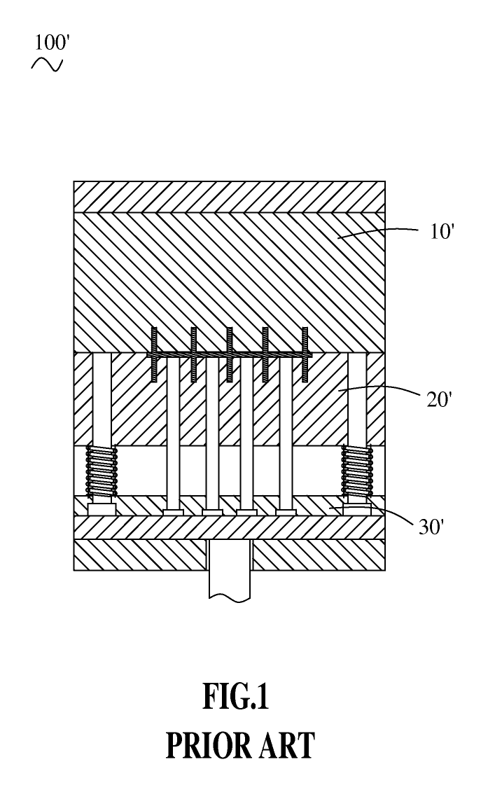

FIG. 2 is a cross-sectional view showing a mold according to the present invention in a mold-closed condition;

FIG. 3 is a cross-sectional view showing mold of FIG. 2 in a mold-open condition; and

FIG. 4 is a cross-sectional view showing mold of FIG. 2 in a completely mold-open condition.

### DETAILED DESCRIPTION OF THE PREFERRED EMBODIMENT

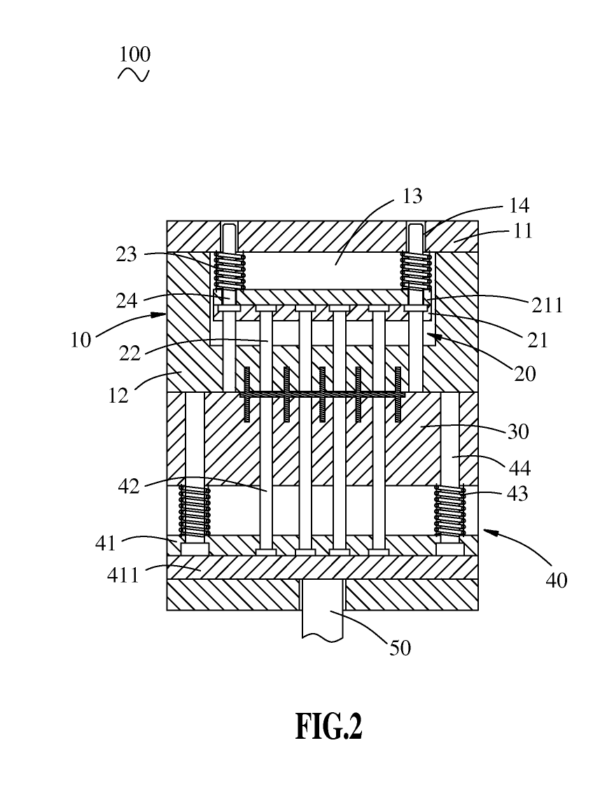

With reference to the drawings and in particular to FIG. 2, the present invention provides a mold, generally designated as 100. The mold 100 comprises a static mold 10, a static-mold ejector mechanism 20, a dynamic mold 30 which mates with the static mold 10, and a dynamic-mold ejector mechanism 40 which is driven by an ejector rod 50.

Referring to FIGS. 2 to 4, the static mold 10 comprises an upper fixing plate 11 and a static-mold plate 12, and the static mold 10 has a static-mold moving-space 13 formed between the upper fixing plate 11 and the static-mold plate 12. The upper fixing plate 11 is provided with positioning-rod holes 14 which communicates the static-mold moving-space 13 and extends through the static mold 10 in the direction toward the dynamic mold 30.

The static-mold ejector mechanism 20 is movably mounted in the static mold 10 and comprises a static-mold ejector plate 21 which is mounted in the static-mold moving-space 13, a plurality of static-mold ejector components 22, a plurality of static-mold springs 23, and a plurality of positioning-rods 24 received in the positioning-rod holes 14. In addition, the static-mold ejector plate 21 comprises a static-mold ejector fixing plate 211.

The plurality of static-mold ejector components 22 and positioning-rods 24 are fixed on the static-mold ejector plate 21. The static-mold springs 23 respectively encompass the positioning-rods 24 and can push the static-mold ejector plate 21, and the static-mold ejector plate 21 drives the plurality of positioning-rods 24 against the dynamic mold 30. The upper ends of the static-mold ejector components 22 are movably put in the static-mold moving-space 13 and can be driven by the static-mold springs 23; and the lower ends of the static-mold ejector components 22 can push a finished-product (not labeled) out of the static mold 10. In addition, a gap is present between the static-mold ejector plate 21 and the lower surface of the static-mold moving-space 13 in a mold-closed condition.

The dynamic-mold ejector mechanism 40 comprises a dynamic-mold ejector plate 41, a plurality of dynamic-mold ejector components 42, and a plurality of dynamic-mold springs 43. The dynamic-mold ejector plate 41 comprises a dynamic-mold ejector fixing plate 411. A plurality of dynamic-mold guide-rods 44 is mounted on the dynamic-mold ejector fixed plate 411 and extends to the upper surface of the dynamic mold 30, wherein the plurality of dynamic-mold ejector components 42 is mounted on the dynamic-mold ejector fixed plate 411, and the plurality of dynamic-mold springs 43 respectively encloses the plurality of dynamic-mold guide-rods 44.

Referring to FIG. 2, when the mold 100 is closed, the plurality of static-mold springs 23 is compressed.

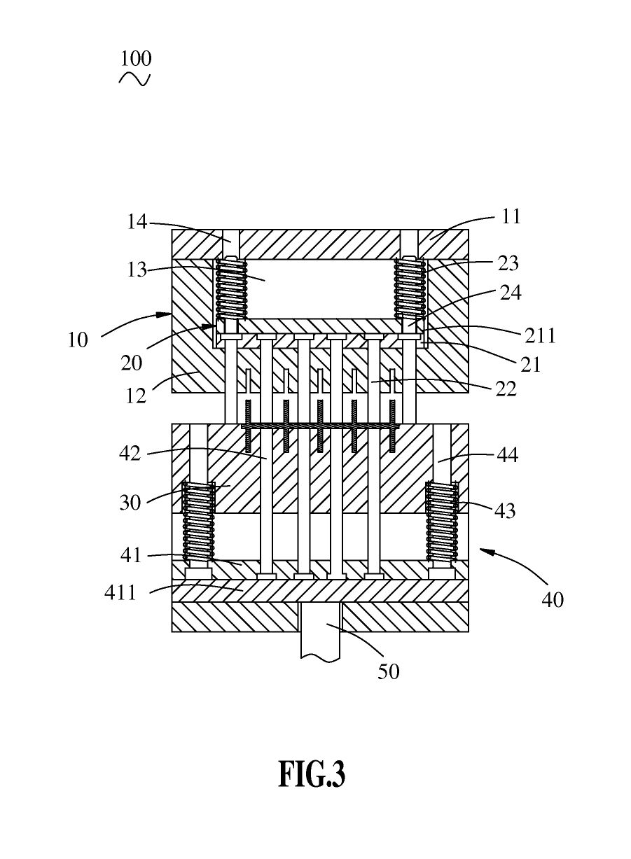

Referring to FIG. 3, when the mold 100 is opened, the plurality of static-mold spring 23 pushes the static-mold ejector plate 21, and the static-mold ejector plate 21 drives the static-mold ejector components 22 against the finished-product, and then the finished-product is remove out of the static mold 10.

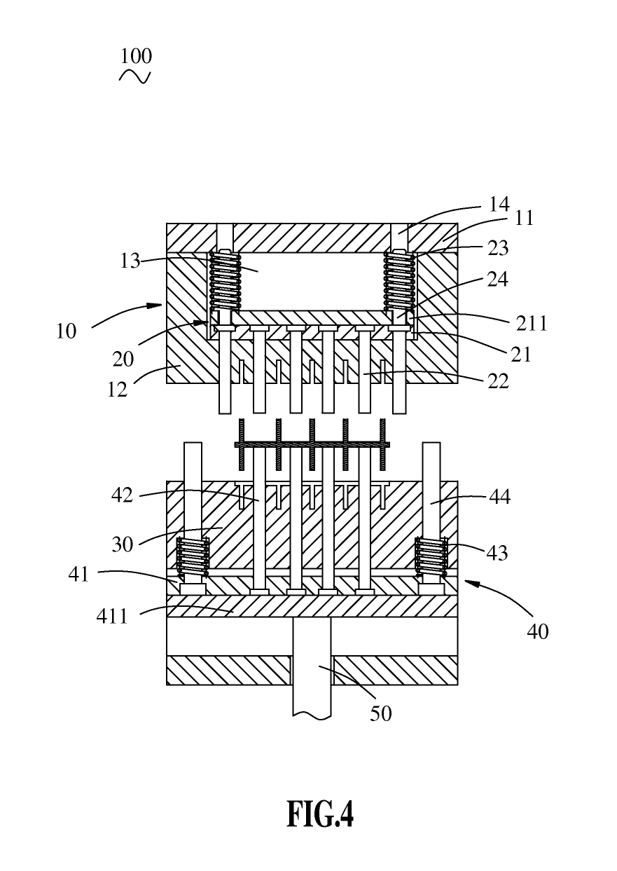

Referring to FIG. 4, when the mold 100 is completely opened, the ejector-rod 50 pushes the dynamic-mold ejector fixing plate 411, and the dynamic-mold ejector fixing plate 411 drives the plurality of dynamic-mold ejector components 42, and the plurality of dynamic-mold ejector components 42 pushes the finished-product out of the dynamic mold 30.

Referring to FIG. 2, when the mold 100 is closed again, the plurality of positioning-rods 24 is pushed by a push-action of the upper surface of the dynamic mold 30, and the plurality of positioning-rods 24 drives the static-mold ejector plate 21 to move to the standby-location. Furthermore, the plurality of dynamic-mold guide-rods 44 is pushed by a push-action of the lower surface of the static mold 10, and the plurality of dynamic-mold springs 43 pushes the dynamic-mold ejector plate 41 to move to the standby-location. Therefore, the mold 100 is returned to the mold-close condition and waiting for the next operation.

As described above, the mold 100 according to the present invention can prevent the finished-product from sticking to a static mold 10 with the arrangement of the static-mold ejector mechanism 20, which provides the static-mold springs 23 pushing the static-mold ejector plate 21 to drive the static-mold ejector components 22 to push the finished-product out.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A mold, comprising:
a static mold, having a static-mold moving-space and a positioning-rod hole;
a static-mold ejector mechanism, being movably mounted in the static mold and comprising a static-mold ejector plate mounted in the static-mold moving-space, at least one static-mold ejector component, at least one positioning-rod being movably received in the positioning-rod hole, and at least one static-mold spring, the static-mold ejector component and the positioning-rod are mounted on the static-mold ejector plate;
a dynamic mold, mating with the static mold; and
a dynamic-mold ejector mechanism, being movably mounted in the dynamic mold;
wherein the positioning-rod hole extends through the static mold in the direction toward the dynamic mold, and the static-mold spring pushes the static-mold ejector plate to drive the positioning-rod against the dynamic mold.

2. The mold as claimed in claim 1, wherein the mold having a static mold comprises an upper fixing plate and a static-mold plate, and a static-mold moving-space is formed between the upper fixing plate and the static-mold plate.

3. The mold as claimed in claim 2, wherein the static-mold ejector plate comprises a static-mold ejector fixing plate, the static-mold ejector component being mounted on the static-mold ejector fixing plate, the static-mold spring enclosing the positioning-rod.

4. The mold as claimed in claim 3, wherein the dynamic-mold ejector mechanism comprises a dynamic-mold ejector plate, at least one dynamic-mold ejector component, and at least one dynamic-mold spring, the dynamic-mold ejector plate comprising a dynamic-mold ejector fixing plate, at least one dynamic-mold guide-rod being mounted on the dynamic-mold ejector fixed plate the dynamic-mold spring enclosing the dynamic-mold guide-rod.
